(19) United States
(12) Patent Application Publication
(10) Pub. No.: US 2019/0081503 A1
(43) Pub. Date: Mar. 14, 2019

(54) INTERNET OF THINGS SMART HOME/BUILDING AUTOMATION SYSTEM FOR CUTTING OFF NETWORK STANDBY POWER, AND CONTROL METHOD FOR SAME

(71) Applicant: Chang-Ho KIM, Anyang-si (KR)

(72) Inventor: Chang-Ho KIM, Anyang-si (KR)

(21) Appl. No.: 16/084,292

(22) PCT Filed: Mar. 14, 2017
(86) PCT No.: PCT/KR2017/002717

§ 371 Date: Sep. 12, 2018

(30) Foreign Application Priority Data
Mar. 14, 2016 (KR) 10-2016-0030252

(51) Int. Cl. H02J 9/00; H01R 13/70; H02J 50/12; H04L 12/28

(52) U.S. Cl. CPC H02J 9/005; H01R 13/70; H02J 2009/007; H04L 12/2816; H02J 50/12

(57) ABSTRACT

Disclosed is an internet of things (IoT) smart home/building automation system (IoT smart system) for cutting off network standby power, the system comprising: a master which performs a hub function and a control function and comprises at least one of communication modules, a power source switching unit, a power source supply/cut-off module, a wired/wireless power transmitting/receiving unit which is a means supplying a wake-up power that causes the operation of various IoT devices, a power source unit, and a router or gateway for connection with an external network and a IoT smart system platform over a cloud; a smart multi-socket which, by connecting with a smart socket (one socket or a multi-socket with multiple sockets) that connects to a conventional power source socket, and connecting IoT devices for which the network standby power is in a cut-off state, receives wake-up power from the master and supplies wake-up power to the IoT devices; IoT devices having a structure so as to cut off the network standby power and the standby power for the devices themselves, and IoT devices for which a power source is always supplied; IoT devices comprising at least one sensor operated by a battery; and a non-IoT smart socket which can connect non-IoT devices to the system.

### CROSS-REFERENCE TO RELATED APPLICATIONS

This patent application is a national-stage application of International Patent Application No.: PCT/KR2017/002717, filed on Mar. 14, 2017, which claims priority under 35 U.S.C. § 119 to Korean Patent Application No. 10-2016-0030252, filed on Mar. 14, 2016, in the Korean Intellectual Property Office, the disclosures of which are incorporated by reference herein in their entireties.

### TECHNICAL FIELD

The present invention relates to an Internet-of-things (IoT) smart home/building automation system (hereinafter, “IoT smart system”), and more particularly, to technology to completely cut off network standby power which is consumed by electronic products or devices connected to the IoT system as the electronic products or devices performs no process but simply wait for occurrence of an event and the electronic devices' own standby power which is consumed even when they are powered off, thereby avoiding waste of power.

Further, the present invention relates to technology able to cut off network standby power while reducing the power consumption of individual devices by cutting off power to devices (e.g., refrigerators, bidets, or electric ranges) which typically remain powered upon use when they meet a predetermined control condition and resuming the power supply upon failing to meet the control condition.

The present invention also relates to IoT smart system technology able to cut off network standby power and devices' own standby power while allowing existing non-IoT devices to connect to the IoT smart system without the need for physically replacing with IoT devices.

The present invention also relates to technology able to cut off network standby power and devices' own standby power that are consumed from smart receptacles and to cut off the smart receptacles' own power consumption even while IoT devices connected to the smart receptacles are being operated.

### DISCUSSION OF RELATED ART

Spreading IoT technology in various sectors is leading to the technology being adopted in IoT smart systems. As IoT technology applies, IoT devices connected together always consume network standby power in a so-called ‘network standby state’ where the IoT devices are on standby even when they perform no task or process because they are unaware when data is transmitted or received. Thus, the overall power consumption is expected to exponentially increase as more and more electronic products or devices are out there.

To address such increase in power consumption, the International Energy Agency (IEA) advises each country to figure out a measure for reducing unnecessary power waste and regulate (more power of about 850 TWH is probably required for the overall power in year 2020)

The 2015 G20 submit has chosen an action plan to prepare for a measure to saving power consumption (January 2015).

However, no noticeable approach has been proposed yet except for minimizing power consumption on individual semiconductor devices used for networks. Thus, it is obvious that as more and more devices are connected to the IoT, the devices' network standby power consumption and their own standby power consumption in the standby state are drastically increased.

To address the same, tremendous investment should be made in establishing power plants and relevant power transmission/distribution infrastructures, leaving cost issues. Some approaches have been suggested, such as standby power saving devices disclosed in Korean Patent Application Nos. 10-2015-0003210, 10-2015-0009076, and 10-2015-0028858, all of which have been filed by the applicant in Korean Intellectual Property Office. However, the techniques disclosed therein propose a configuration in which a separate ethernet connector or USB connector is required as power supply means to control the supply of power to the electronic device only when necessary. The need for such a separate connector in the configuration is still inconvenient to users.

Further, the solutions disclosed in the prior applications regard a method of wiring smart receptacles to the central management device and IoT devices. Thus, installation may be simple when the system applies to newly founded buildings but it would not to apply to existing buildings and it would be tricky for unskilled persons to install. Therefore, a need exists for a way to enable easier installation while resolving the inconvenience issue.

What should be considered as well is that the smart receptacles themselves still consume power while the IoT devices are in operation.

In existing home/building automation systems, the devices cannot be relocated because they are connected in hardware and have unchanged addresses, and their position is fixed per type so that they require re-registration when moved. Further, techniques for manually or remotely supplying/cutting off power to devices are disclosed in Korean Patent Nos. 10-0945210, 10-0945213, and 10-0934970, which have been issued to the applicant. These Korean patents should be considered as reference documents.

### SUMMARY

Accordingly, an object of the present invention is to provide an Internet-of-things (IoT) smart home/building automation system (hereinafter, “IoT smart system”), and a method for controlling the same, which may supply power to various electronic products and/or electrical devices (e.g., cooling or heating devices, TVs, refrigerators, washers, electrical ranges, microwaves, dish washers, security/disaster prevention devices, humidifiers or dehumidifiers, but not limited thereto) connected via IoT, only when necessary—and hence reducing power consumption—by cutting off network standby power in the device power-off state or network standby state where the devices process no task.

Another object of the present invention is to provide an IoT smart system, and a method for controlling the same, which may be built up by connecting smart power strips to existing power outlets without separate installation on existing buildings and inserting the power plugs of IoT devices to the smart power strips to connect the IoT devices to the smart power strips, thereby automatically cutting off the network standby power of the IoT system and the own standby power of the devices.

Still another object of the present invention is to provide an IoT smart system, and a method for controlling the same, which may provide a wake-up power supply path and device input power supply paths only when necessary for the smart power strips so that the smart power strips do not consume power on their own even while the IoT devices operate. The IoT devices registered in the IoT system may be recognized and controlled without the need for re-registration even when plugged into other power outlets in the system. Existing non-IoT devices which cannot be connected to the IoT smart system may also be allowed to connect to the IoT smart system. This may lead to further reduced power consumption than in homes or buildings not adopting the IoT smart system, thus contributing to power savings.

Further, from a nationwide point of view, the present invention may eliminate the need for investment in facilities to get ready for increases in power consumption, thus leading to cost savings, reduction in carbon dioxide emissions, and hence preventing environmental contamination.

Adopting such IoT smart systems more and more may further reduce power consumption, lead to more convenience in daily life, and promote the development of IoT industry.

To achieve the above objects, as per an exemplary aspect of the present invention, there is provided an IoT smart system, and a method for controlling the same, to perform control to automatically cut off the network standby power in the IoT system and the standby power of the devices and configured by connecting smart power strips to existing power outlets without separate installation on existing buildings and inserting the power plugs of various IoT devices to the smart power strips, the IoT smart system comprising: a master (1) including a wired/wireless power transmitter (13), as a means to supply wake-up power to trigger operations of a gateway or a router (12) for connecting an IoT smart system platform to an external network over a cloud, a power unit 15, and various IoT devices, a power supply/cutoff module (17), a power switching unit (19), and/or a communication module (11) and performing a hub function and control function;

a smart power strip (6 or 6′) connected to a smart outlet (a single or multi-tap power strip) connecting to an existing power outlet (3) to connect IoT devices (4 and 5) which remain cut off from network standby power, receiving wake-up power from the master (1) to supply wake-up power to the IoT devices;

IoT devices (4) including a configuration for cutting off the network standby power and their own standby power and IoT devices (5) configured to remain (24 hours) powered;

IoT devices including at least one battery-powered sensor; and a non-IoT smart power strip (a single or multi-tap power strip) configured to connect the non-IoT devices to the system.

Further, according to an aspect of the present invention, there is provided an IoT smart system that allows for both wireless and wired power transmission/reception schemes as a means to wake up the devices when an event occurs while the devices remain powered-off, may cut off the standby power of the devices and the network standby power of the devices by configuring an IoT smart system hardware platform in home/building with a master and various smart power strips.

Further, to address the problems that wireless power transmission/reception suffers from poor communication efficiency and the transmission distance is short so that it is hard to make commercial due to being significantly influenced by the structure or environment, there are provided a power plug with a wake-up power transmitter therein to wake up the device, a power plug with a wake-up power receiver therein, a power plug insertion hole with a wake-up power transmitter therein in the smart outlet, and a power plug insertion hole with a wake-up power receiver therein, wherein the power plug with the wake-up power receiver is inserted into the power plug insertion hole with the wake-up power receiver of the smart outlet so that they may match each other, or conversely, the power plug with the wake-up power transmitter is inserted into the power plug insertion hole with the wake-up power receiver.

Preferably, as another approaching method, there is provided an IoT smart system configured so that the wireless power transceiver to awaken the device may be extended to the outside to be replaced in the position where wireless power transmission and reception may be performed better. In this case, the system may be configured with no smart power strip.

Further, preferably, as a method for wired transmission/reception, no separate Ethernet connector or USB connector or other separate cable connections are required, and connectors are provided in the power plug insertion hole of the smart outlet and the power plug, and if the power plug is inserted into the power plug insertion hole of the smart outlet, paths for supplying power and wake-up power are provided for mutual connection.

Further, where input power is DC power, the smart outlet may be replaced with a USB PD connector-USB c-type cable connectable hub. More preferably, further included is a means to manually power on or off the IoT device even in the power-off state.

The IoT smart system, and method for controlling the same, which control to automatically cut off the network standby power of the IoT smart system and the standby power of the devices, are described below in greater detail from the following description and claims.

The present invention may completely cut off the standby power which is wasted when the electronic devices connected with the IoT smart system are powered off and the network standby power which is wasted in the network standby state where the devices wait without processing any event, thereby reducing power waste.

Thus, where as many electronic products or devices as the number of prior ones are used, connecting and using the IoT-applied devices may significantly reduce power consumption as compared with current power consumption, further relieving the users of utility bill, facilitating to build up systems, and leading to easier connection of such IoT devices. By reducing unnecessary power waste as set forth above, carbon dioxide emissions may also be reduced, preventing environmental contamination and hence allowing for more convenience in life while adding values.

### BRIEF DESCRIPTION OF THE DRAWINGS

The foregoing and other features, aspects, and advantages of the present invention will be apparent from the detailed description taken in conjunction with the accompanying drawings. The same reference denotations are intended to refer to the same or similar members or elements throughout the drawings, wherein:

FIG. 1 is a view illustrating an example of a configuration of an IoT smart home/building automation system (hereinafter, ‘IoT smart system’) according to an embodiment of the present invention;

FIG. 2 is a view illustrating a shape of a smart power strip (smart power strip) as a component device according to an embodiment of the present invention;

FIG. 3 is a view illustrating an example of an internal configuration of a smart power strip according to an embodiment of the present invention;

FIG. 4 is a view illustrating an example of a configuration of an IoT device, as a component device, which is not cut off from power when being used according to an embodiment of the present invention;

FIG. 5 is a view illustrating an example of a configuration of an IoT device, as a component device, according to an embodiment of the present invention;

FIG. 6 is a view illustrating an example of a configuration of a repeater configured, as a component, to relay/amplify signals for seamless communication in a poor communication environment;

FIG. 7 is a view illustrating an example of a configuration of a master, as a component device, according to an embodiment of the present invention;

FIG. 8 is a view illustrating an example of a configuration of a non-IoT smart receptacle (non-IoT smart outlet) for connecting an existing non-IoT device to an IoT smart system according to an embodiment of the present invention;

FIG. 9 is a view illustrating an example of a configuration of a wireless power transceiver according to an embodiment of the present invention;

FIG. 10 is a view illustrating an example of an outer appearance of a built-in smart receptacle according to an embodiment of the present invention;

FIG. 11 is a view illustrating an example of a configuration of a power plug with a wireless power transmission/reception means and power plug insertion holes according to an embodiment of the present invention;

FIG. 12 is a view illustrating an example of a configuration of another power plug with a wireless power transmission/reception means and power plug insertion holes according to an embodiment of the present invention;

FIG. 13 is a view illustrating an example of a configuration of a power plug with a wired power transmission/reception means and power plug insertion holes according to an embodiment of the present invention;

FIG. 14 is a view illustrating an example in which a power plug with a wired power transmission/reception means is connected to power plug insertion holes according to an embodiment of the present invention; and

FIG. 15 is a view illustrating an example of a configuration of an IoT smart system with no smart power strip in another configuration according to an embodiment of the present invention.

### DESCRIPTION OF EXEMPLARY EMBODIMENTS

The description below is provided for aid in understanding exemplary embodiments of the present invention and equivalents thereof defined by the appended claims. Although the description sets forth various details for a better understanding of the present invention, they should be regarded merely as examples. Therefore, it will readily be appreciated by one of ordinary skill in the art that various changes or modifications may be made to the embodiments set forth herein without departing from the scope and concept of the present invention.

Although any element or objection is expressed in singular form, it should be intended as encompassing plural elements or objects unless explicitly stated otherwise.

The terms “substantially,” “about,” and “essentially” as used herein does not essentially mean that any feature, parameter, or value need to be an exact one, but is intended to mean that a slight tolerance or variation may be made thereto which is known to one of ordinary skill in the art to exhibit the same effects despite the tolerance or variation.

The detailed description of known functions or elements may be omitted from the description of the embodiments of the present invention for clarity and simplicity of the disclosure.

As used herein, the term “electronic product” or “electric device” encompasses, in concept, e.g., room cooling/heating device, TV, refrigerator, washer, electric range, microwave, dish washer, security/emergency device, humidifier/dehumidifier, or computer (including a laptop computer, netbook, PDA, tablet PC, or other terminal), which is connected to the power outlet in a home or building or is rechargeable via the power outlet, but not necessarily limited thereto. Hereinafter, the devices or products are referred to simply as an “(electronic) product” or “(electric) device” for ease of description.

For reference, all the machine-to-machine (M2M)-related descriptions set forth in the drawings may be interpreted as those of Internet-of-things (IoT) in the disclosure. As used herein, the terms “module” and “component unit” are intended to be substantially the same or similar in meaning.

Hereinafter, preferred embodiments of an IoT smart home/building automation system (hereinafter, “IoT smart system” for ease of description) with the functionality of cutting off standby power from electronic products and a method for controlling the same, according to the present invention, are described with reference to the accompanying drawings.

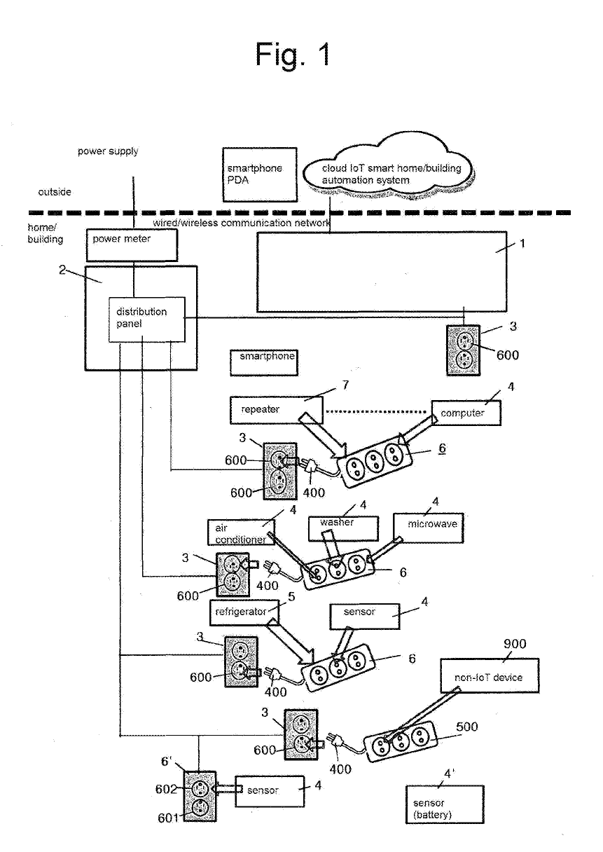

FIG. 1 is a view illustrating an example of a configuration of an IoT smart system according to an embodiment of the present invention. Referring to FIG. 1, one IoT smart system (hardware platform) including an IoT smart platform, a master 1, smart receptacles, and IoT devices (remote terminals) are configured on a cloud.

A configuration of the IoT smart system according to the present invention is described below in detail with reference to FIG. 1 and FIGS. 2 to 15.

Referring to FIG. 1 the IoT smart system of the present invention includes a master 1 including a wired/wireless power transmitter 13, as a means to supply wake-up power to trigger operations of a gateway or a router 12 for connecting an IoT smart system platform to an external network over a cloud, a power unit 15, and various IoT devices, a power supply/cutoff module 17, a power switching unit 19, and/or a communication module 11 and performing a hub function and control function; for existing buildings, a smart power strip (6) (which may be replaced with a built-in smart power strip (6′) for newly founded buildings) connected to a smart power outlet (a single or multi-tap power strip) for connecting to an power outlet 3 to connect the IoT devices 4 and 5 which remain cut off from network standby power and to receive wake-up power from the master 1 to supply wake-up power to the IoT device;

IoT devices 4 with a configuration to cut off standby power and the network standby power and IoT devices 5 powered 24 hours;

a repeater 7 to amplify signals in the middle to enable seamless signal transmission/reception when wireless power transmission/reception is not seamless by the building structure; IoT devices 4′ battery-powered (including, e.g., sensors); and a non-IoT smart outlet provided to connect non-IoT devices 900 to the system.

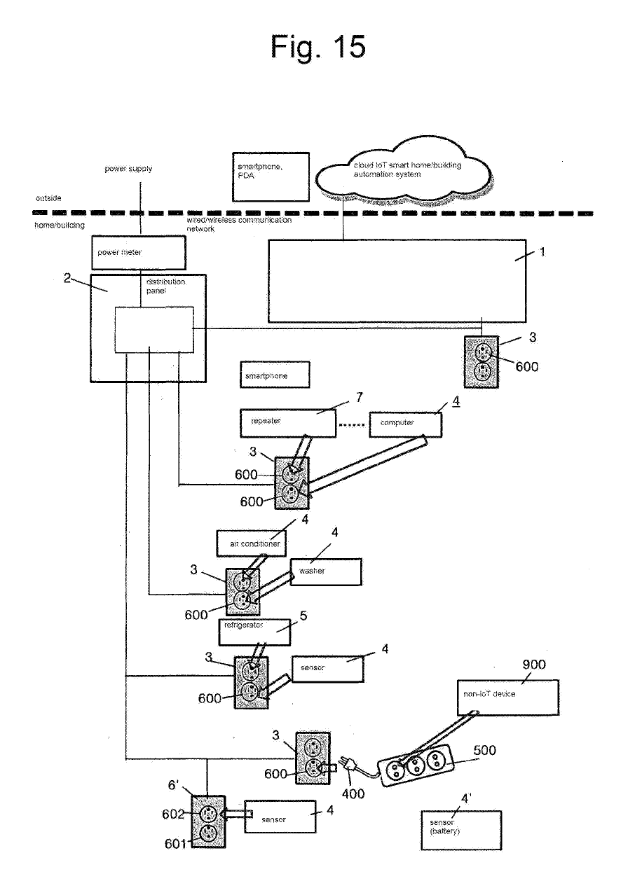

If wake-up power is implemented with resonant wireless power transmission/reception, the IoT smart system may be configured more simply even with no smart power strip 6 as shown in FIG. 15.

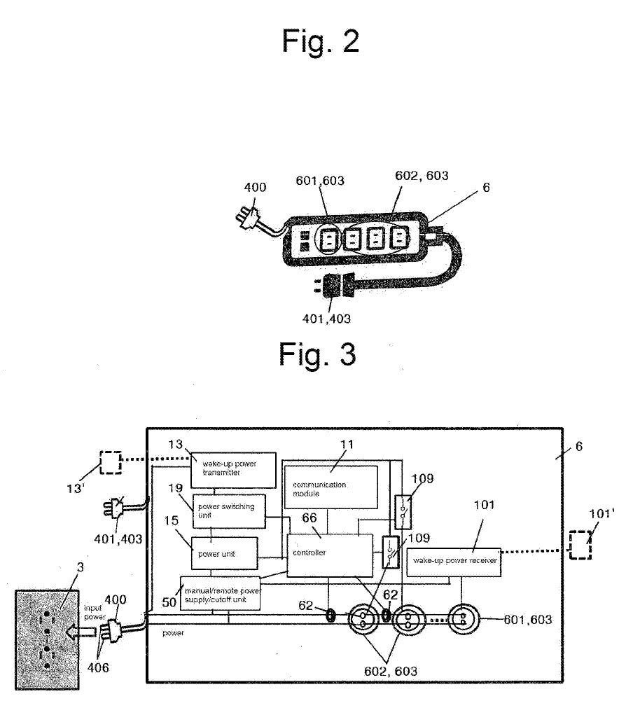

FIG. 2 is a view illustrating a preferred example of a shape of a smart power strip (smart power strip) 6 as a component device according to an embodiment of the present invention.

Referring to FIG. 2, the smart power strip includes a power plug 400 connected to an existing, normal outlet 3, a power plug 401 and 403 configured to supply power and transmit wake-up power so as to extend to another smart power strip, power plug insertion holes 602 and 603 with a transmitter to provide wake-up power to a device, and power plug insertion holes 601 and 603 with a receiver to receive input power and wake-up power from the master 1 or another smart power strip 6.

FIG. 3 is a view illustrating an example of a configuration of a smart power strip 6 as another component device according to an embodiment of the present invention. Referring to FIG. 3, the configuration of the smart power strip 6 includes a wake-up power receiver 101 provided in the smart power strip 6 or the power plug insertion holes 601 and 603—or, depending on transmission/reception distance or environment, separately configured outside—to receive wake-up power from the master 1 and configured to provide input power to the power plug insertion holes 601, 602, and 603 of the smart power strip 6 when the insertion terminals 406 of the normal power plug 400 are inserted to the outlet 3; a manual/remote power supply/cutoff unit 50, as a means (configurable as a latching relay, photo-triac, switch, photo-coupler, or other semiconductor device) to supply input power to the power unit 15 when wake-up power is remotely turned on remotely or manually or to cut off power to the power unit 15 when turned off remotely or manually; the power unit 15 to produce power necessary for the smart power strip 6 and supply the power to the smart power strip 6 when the manual/remote power supply/cutoff unit 50 is operated so that the input power is supplied to the power unit 15 of the smart power strip 6; a controller 66 including a memory and a microcomputer (micom) performing the overall control of the smart power strip 6, including gathering data, identifying or determining whether the device is one connected thereto, performing computation, storing data, and controlling; a communication module 11 for communicating with the master 1; power plug insertion holes 602 and 603 or wake-up power transmitter 13 or 13′ configured to transmit wake-up power to another smart power strip 6 connected thereto and IoT devices 4 and 5 registered therein when wake-up power is received from the master 1; a power switching unit 19 configurable to include a relay or semiconductor device (FET) to supply/cut of power from the power unit 15 to the wake-up power transmitter 13 or 13′ under the control of the controller 66; a switching unit 109 configurable to include a relay or semiconductor device (FET) to supply/cut off wake-up power only to the IoT devices 4 and 5 registered therein under the control of the controller 66; a current sensor 62 configured to detect the current of the IoT devices 4 and 5 connected thereto to detect standby power, and if the current is not detected, to determine whether the device is unplugged or relocated; and power plugs 401 and 403 to supply wake-up power produced from the wake-up power transmitter 13 to another smart power strip 6 or 500 connected for extension.

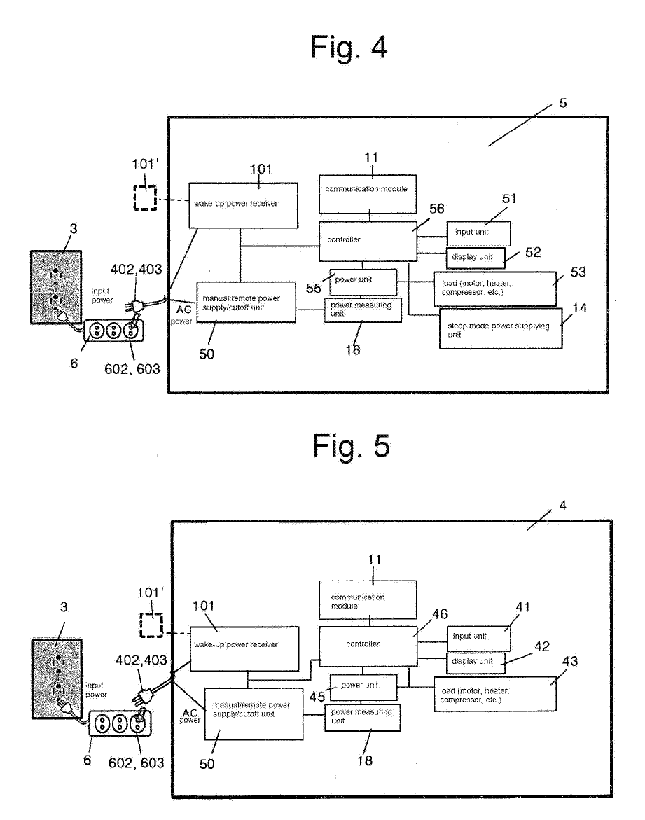

FIG. 4 is a view illustrating an example of a configuration of an IoT device 5 (e.g., a refrigerator, bidet, or electric range) that remains powered all the time when used, according to an embodiment of the present invention. Referring to FIG. 4, the IoT device 5 includes a manual/remote power supply/cutoff unit 50 configurable to include a semiconductor device (not shown), such as a latching relay, photo-triac, switch, or photo-coupler, as a means to supply input power or manually or remotely cut off the input power under the control of a controller 56 to prevent the IoT device 5 from malfunctioning due to a voltage drop that occurs as a sleep mode power supply unit 14 is discharged or as the input power is supplied manually or remotely with the IoT device cut off from power; a power plug 402 or 403 configured to be inserted to the power plug insertion hole 602 or 603 of the smart power strip 6 to receive input power and wake-up power from the manual/remote power supply/cutoff unit 50 so as to remotely supply power to the IoT device 5; a wake-up power receiver 101 or wake-up power receiver 101′ functioning as a means to receive wake-up power and configured extendably inside or outside the IoT device 5 to wirelessly receive wake-up power in a case where the system is configured without use of the smart power strip; a power unit 55 to produce power necessary for the IoT device and supply the power if the manual/remote power supply/cutoff unit 50 is turned on so that the input power is supplied to the power unit 55 of the IoT device 5; a controller 56 including a memory and a microcomputer as a means to control and process all events and communication of the IoT device 5 if power is supplied from the power unit 55; a communication module 11 (configurable as a Wi-Fi, Z-wave, Zigbee, or Bluetooth module or unit) as a means to communicate with devices connected with the system and the master 1; an input unit 51 as an input means configured to receive IR signal inputs or inputs from various sensors, a switch or touch switch; a display unit 52 as a means to display the state of the IoT device 5, a load 53 configured as, e.g., a motor, heater, or compressor, inside the IoT device 5, as a means to perform control conditions of the IoT device 5; the sleep mode power unit 14 configurable as a super capacitor or battery (not shown) as a means to supply power to as few circuit components, including the microcomputer, as possible in the sleep mode where power is supplied to as few circuit components as possible to receive IR signals or input from the touch switch in the context where the IoT device 5 is powered off; and a power measuring module 18 configured to measure power consumed while the IoT device 5 is operated.

FIG. 5 is a view illustrating an IoT device 4 of an IoT smart system according to an embodiment of the present invention. Referring to FIG. 5, the IoT device 4 includes a manual/remote power supply/cutoff unit 50 as a means (configurable as a latching relay, photo-triac, switch, photo-coupler, or other semiconductor device) to manually or remotely supply input power with power cut off or to cut off the input power manually or under the control of a controller 46; a power plug 402 or 403 configured to be inserted to a power plug insertion end 602 or 603 of the smart power strip 6 to remotely wake up the IoT device 4 to receive the input power and wake-up power to manually/remotely supply the wake-up power to the manual/remote power supply/cutoff unit 50, a wake-up power receiver 101 or 101′ extendably configured inside or outside the IoT device 4 and configured as a means to wirelessly receive wake-up power and to supply the wake-up power to the manual/remote power supply/cutoff unit 50 in a case where it is configured without the smart power strip 6; a power unit 45 to produce power necessary for the IoT device 4 and supply the power if the input power is supplied via the manual/remote power supply/cutoff unit to the power unit 45; a controller 46 including a memory and a microcomputer and performing functions as a means to process and control all the events of the IoT device 4 if power is supplied from the power unit 45; a communication module 11 (configurable as a Wi-Fi, Z-wave, Zigbee, or Bluetooth module) for communicating with devices connected to the system and the master 1; an input unit 41, as an input means, configured to receive input values of various sensors and inputs of a switch; a display unit 42 as a means to display the state of the IoT device 4; a load 43 configured to include a motor, heater, or compressor of the IoT device, as a means to meet control conditions for the IoT device 4; and a power measuring module 18 to measure power consumed while the IoT device 4 is operated.

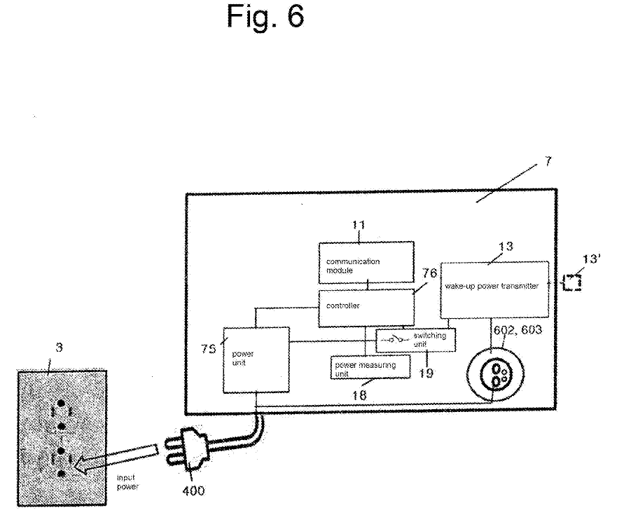

FIG. 6 is a view illustrating an example of a configuration of a repeater to amplify wireless signals and to relay wireless signals for seamless communication in a poor communication environment according to an embodiment of the present invention.

Referring to FIG. 6, the repeater 7 serves to enable the IoT smart system to perform seamless communication in a poor wireless communication environment. The repeater 7 includes a power plug 400 inserted to a normal outlet 3 to supply power to the repeater 7; a power unit 75 to produce and supply power necessary for the repeater 7 when the power is supplied; a controller 76 including a memory and a microcomputer functioning as a means to control and process all the events of the repeater 7 when power is supplied from the power unit 75; a communication module (configurable as a Wi-Fi, Z-wave, Zigbee, or Bluetooth module) configured as a means to relay signals for seamless communication between the master 1 and the IoT device; a power switching unit 19, as a power supply/cutoff means, to supply wake-up power to an IoT device 4, 5, or 6 connected to the repeater 7 when the registered ID from data received from the master 1 is identified by the controller 76 and to cut off the supply of power from the power unit 75 to the wake-up power transmitter 13; the wake-up power transmitter 13 or 13′ configured to produce wake-up power and supply the wake-up power to the IoT device 4, 5, or 6 when the power switching unit 19 is operated under the control of the controller 76 so that power is supplied from the power unit 75; and power plug insertion holes 602 and 603 with the wake-up power transmitter configured to transmit wake-up power.

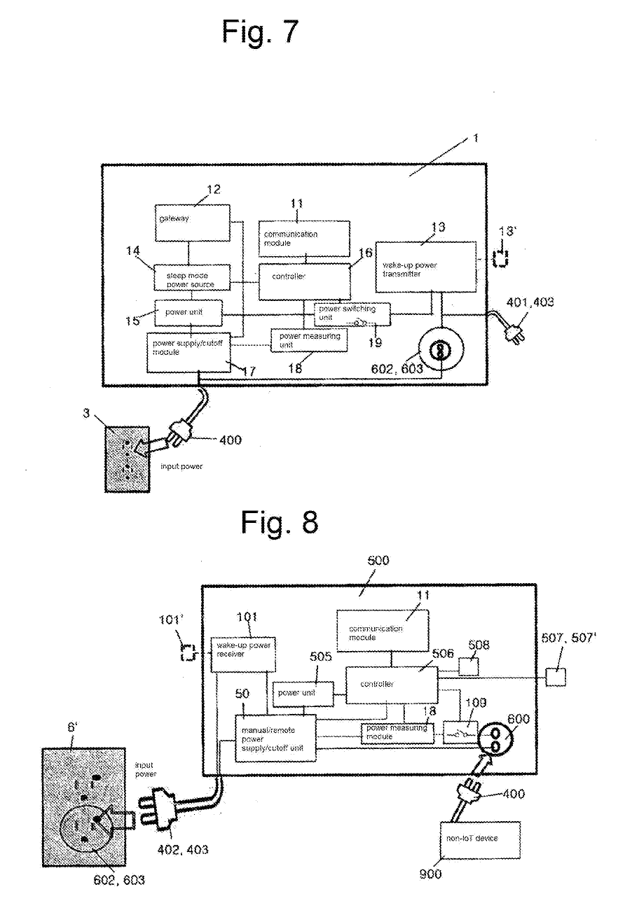

FIG. 7 is a view illustrating an example of a configuration of a master 1, as a component device, according to an embodiment of the present invention. Referring to FIG. 7, the master 1 according to an embodiment of the present invention includes a gateway 12 for connection with an external communication network; a power supply/cutoff unit 17 to supply, and cut off the supply of, power to the master 1 and a power plug 400 for connection to an outlet 3 for supplying input power to the master 1; a power unit 15 to produce and supply power necessary for the master, such as power for a wake-up power transmitter for wireless power transmission, or power for wired power transmission when a power switching unit 19 is connected and power necessary for the master 1 when power is supplied; a communication module 11 (configurable as a Wi-Fi, Z-wave, Bluetooth, Zigbee, or IR communication module) for wireless communication with IoT devices 4, 4′, and 5 in the internal network; a sleep mode power unit 14 configurable as a battery or super capacitor which is a means to supply power to only some circuit components, such as a controller 16 and the communication module 11, by cutting off network standby power which may be wasted when there is no event processing; a power supply/cutoff module 17 to supply power when there is event processing and cut off input power when there is no event processing; the controller 16 configured to include a membership and a microcomputer as a means to perform all kinds of control regarding a control event when the control event is received from the inside or outside or a means to gather data including an own IP or ID and relevant data, compute, determine, and/or control, and store data; a wake-up power transmitter 13 or 13′ as a means to supply wake-up power to wake up the IoT devices 4 and 5 and the smart power strip 6 which have been cut off from power when the IP and ID are identified by the controller 16; a power switching unit 19 functioning to supply, and cut off the supply of, power so that power from the power unit 15 is supplied under the control of the controller 16 only when wake-up power is necessary via wired connection with the wake-up power transmitter; a power measuring module 18 configured with, e.g., a current sensor to measure power consumed by the master 1; a power plug 401 with the wake-up power transmitter 13 to transfer wake-up power to the smart power strip 6 or a power plug 403 to allow wake-up power to be wiredly supplied via the power switching unit 19; and a power plug insertion hole 602 with the wake-up power transmitter to transfer wake-up power via the power plug insertion hole or a power plug insertion hole 603 to wiredly supply wake-up power via the power switching unit.

FIG. 8 is a view illustrating a non-IoT smart outlet 500 for connecting non-IoT devices, which cannot be connected with the system, to the IoT smart system according to an embodiment of the present invention. Referring to FIG. 8, the non-IoT smart outlet 500 includes a wake-up power receiver 101 or 101′ provided inside or outside to receive wake-up power in a resonant wireless power transmission/reception scheme or having a power plug 402 or 403 matching a power plug insertion hole 602 or 603 of a smart power strip 6 or 6′; a manual/remote power supply/cutoff unit 50 (configurable as a semiconductor device (not shown), such as a latching relay, photo triac, switch, or photo-coupler), as a means to supply, and cut off the supply of, power to the non-IoT smart outlet 500 when the non-IoT smart outlet 500 is cut off from power, which is controlled, when power is remotely supplied, to maintain a path for supply of power to the non-IoT smart outlet 500, which is manually operated, even when the supply of power is cut off, to maintain the power supply path, and which cuts off the supply of power according to a control signal from a controller 506; a power unit 505 to produce and supply power necessary for the non-IoT smart outlet when the manual/remote power supply/cutoff unit 50 is operated so that input power is supplied to the power unit 505; the controller 506 including a memory and a microcomputer as a means to process and control all the events of the non-IoT smart outlet 500 when power is supplied from the power unit 505; a communication module 11 (configurable as a Wi-Fi, Z-wave, Zigbee, or Bluetooth module) as a means to communicate with devices connected with the system and the master 1; a power measuring module 18 including, e.g., a current sensor (not shown) to measure standby power of a non-IoT device and power consumed while the non-IoT smart outlet 500 is operated; a switching unit 109 configured to include a relay or a semiconductor switching device (not shown) to play a role as a means to supply, or cut off the supply of, input power to the power plug insertion hole 600 under the control of the controller 55 when the ID is identified as one for the non-IoT device 900 registered therein through communication with the master 1;

an input unit 508 functioning as a means to input/register, e.g., the IDs and control codes of the non-IoT devices; an IR transceiver 507 to produce an m signal for controlling the non-IoT device after power is supplied to the non-IoT device and transmit the m signal to the device if the non-IoT device is a device for receiving IR signals or an actuator 507′ configurable as a solenoid or motor if the device is a device that is operated as a switch is pressed; and a power plug insertion hole 600 for insertion/connection of the power plug 400 of the non-IoT device 900.

Meanwhile, more or less switching units 109 and power plug insertion holes 600 may be configured as necessary depending on design.

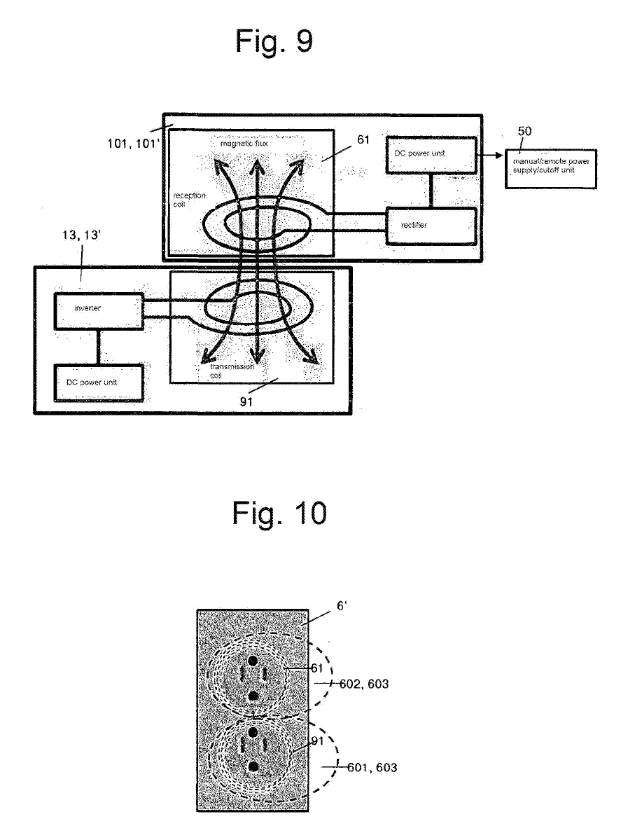

FIG. 9 is a view illustrating an example of a configuration of a wake-up power transmitter/receiver to wirelessly transmit or receive power in an IoT smart system according to an embodiment of the present invention.

Referring to FIG. 9, a wake-up power transmitter 13 or 13′ includes a DC power unit to receive power via a power switching unit 19, an inverter to produce DC power and supply the DC power to a transmission coil 91, and the transmission coil 91 to transmit power via magnetic induction or resonance.

A wake-up power receiver 101 or 101′ includes a reception coil 61 to receive induced power from the transmission coil 91, a rectifier to rectify the voltage induced at the reception coil, and a DC power unit to smooth the rectified power into DC power. Wake-up power produced as the DC power from the DC power unit is operated to supply power to the manual/remote power supply/cutoff units 50 of the IoT devices to wake up the IoT devices 4, 5, and 6 which remain cut off from power, thereby operating the manual/remote power supply/cutoff units 50 of the IoT devices 4, 5, 6, and 500 so that input power is supplied to the IoT devices 4, 5, 6, and 500. The wake-up power transmitter 13 and the wake-up power receiver 101 may include the wake-up power transmitter 13′ and wake-up power receiver 101′, respectively, which are provided outside the device and in a location where a good matching occurs in a poor communication environment or building to enable seamless power transmission and reception.

FIG. 10 is a view illustrating an example of an outer look of a built-in smart outlet 6′, e.g., a built-in smart outlet installed in a newly founded building, according to an embodiment of the present invention. Preferably, the smart outlet 6′ has the same configuration as the smart power strip 6 of FIG. 1.

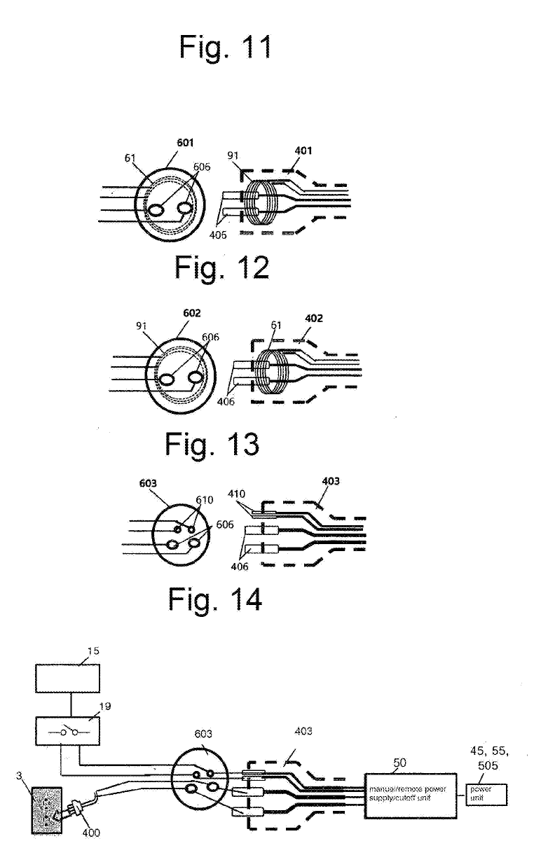

FIG. 11 illustrates an example of a configuration of a power plug with a wireless power transmission/reception means and power plug insertion holes according to an embodiment of the present invention.

A configuration in which wake-up power is transmitted or received and is thus supplied is described in detail with reference to the drawings.

As shown in FIG. 11, when a power plug 401 with a wake-up power transmitter 13 is inserted to a power plug insertion hole 601 with a wake-up power receiver 101, the transmission coil 91 and the reception coil 61 match each other, thus allowing wake-up power to wirelessly be transmitted and received.

Referring to FIG. 12, which has an opposite configuration of that of FIG. 11, a power plug 402 has a wake-up power receiver 101, and a power plug insertion hole 602 has a wake-up power transmitter 13, and when the power plug 402 is inserted to the power plug insertion hole 602, the transmission coil 91 and the reception coil 61 properly match each other, thus allowing wake-up power to wirelessly be transmitted and received. Referring to FIG. 13, for transmission and reception of wake-up power in a wired scheme, a power plug 403 has a connector 410, and a power plug insertion hole 603 has a connector 610. When the power plug 403 is inserted to the power plug insertion hole 603, the connector 410 and the connector 610 are connected to each other, forming a path for supplying wake-up power.

It will be appreciated that the transmission/reception functions may reversely be configured in the power plug 403 and the power plug insertion hole 603. FIG. 14 is a view illustrating an example in which a power plug with a wired power transmission/reception means is connected to power plug insertion holes according to an embodiment of the present invention. Referring to FIG. 14, if the power plug 403 is inserted to the power plug insertion hole 603 in a wired scheme as set forth above, the connector 410 of the power plug is connected with the connector 610 of the power plug insertion hole.

As described above, once wake-up power is produced by the transmission and reception of wake-up power in a wired/wireless scheme, the wake-up power is supplied to the manual/remote power supply/cutoff units 50 of the IoT devices. If the wake-up power is supplied to the manual/remote power supply/cutoff units 50 so that the manual/remote power supply/cutoff units 50 are turned on, input power from the power plug 400 inserted into the outlet 3 is supplied to the power units 15, 45, 55, and 505 of the IoT devices via the manual/remote power supply/cutoff units 50.

Described below are the operation principle and control methods of the IoT smart system with the functionality of cutting off standby power as described above, according to preferred embodiments of the present invention.

Initial steps for the IoT smart system according to the present invention, e.g., ID setting and standby power measurement/setting, are described in detail in the applicant's prior patent applications Nos. 10-2015-0003210 10-2015-0009076, and 10-2015-0028858 which disclose standby power saving devices and the disclosures of which are incorporated by reference herein, and no further detailed description thereof is given below for ease of description. The operation principle and control methods for supplying power to, and controlling, IoT devices 1, 4, 5, 6, and 500 which initially remain cut off power and configured in the smart system, with power supplied to the master 1 are described with reference to the following IoT smart system configuration.

The power plug 401 or 403 of the master 1 is connected to the power plug insertion hole 601 or 603 of the smart power strip 6, and the power plug 400 of the smart power strip 6 is connected to the power plug insertion hole 600 of the outlet 3.

The power plug 402 or 430 of each IoT device 4, 5, and 500 is inserted and connected to the power plug insertion hole 602 or 603 of the smart power strip 6. If the number of power plug insertion holes 602 and 603 of the smart power strip 6 is not enough to connect more IoT devices, the power plug 401 or 403 of the smart power strip 6 may be inserted to the power plug insertion hole 601 or 603 of another smart power strip 6 for extension, thereby securing more power plug insertion holes 602 and 603.

Further, for connection of the non-IoT device 900 to the IoT smart system, the power plug 400 of the non-IoT device is inserted and connected into the power plug insertion hole 600 of the non-IoT smart outlet 500, and the power plug 402 or 403 of the non-IoT smart outlet 500 is inserted and connected to the power plug insertion hole 602 or 603 of the smart power strip 6.

1. Operations when Power is Remotely Supplied from Outside to IoT Device

If power is supplied to the master 1, and a control command is received from the outside through the gateway 12 or is received from the sensor 4 or 4′ and the IoT devices 4, 5, 6, and 500 configured inside, with all the IoT devices 4, 5, 6, and 500 connected with the IoT smart system cut off from power, then the controller 16 of the master 1 undergoes the step of verifying its IP and ID and password, etc., and upon verifying that it is its own, the controller 16 of the master 1 controls the power switching unit 19 to supply power from the power unit 15 to the wake-up power transmitter 13 or 13′ so as to supply power to the IoT device 4, 5, 6, or 500 of the ID.

At this time, the power is converted into wake-up power and transmitted to the power plug insertion hole 601 or 603 of the smart power strip 6 by the wake-up power transmitter 13 or 13′.

The wake-up power received by the wake-up power receiver 101 or 101′ of the smart power strip 6 is applied to the manual/remote power supply/cutoff unit 50 of the smart power strip 6 so that the manual/remote power supply/cutoff unit 50 is operated. Subsequently, input power from the power plug 400 is supplied to the power unit 15 of the smart power strip 6. If the power is supplied to the power unit 15, the power unit 15 produces and supplies power necessary for the smart power strip 6, thereby waking up the smart power strip 6.

At this time, the controller 66 controls the power switching unit 19 to supply power from the power unit 15 to the wake-up power transmitter 13 or 13′ of the smart power strip 6, thereby producing wake-up power and supplying the wake-up power to the IoT device 4, 5, or 500 connected with the power plug insertion hole 602 or 603 of the smart power strip 6.

The wake-up power received by the IoT device 4, 5, or 500 is applied to the manual/remote power supply/cutoff unit 50 of the IoT device 4, 5, or 500 so that the manual/remote power supply/cutoff unit 50 is operated to supply input power to the power unit 55, 45, or 505 of the IoT device 4, 5, or 500, thereby waking up the corresponding device.

2. ID Check and Power Cutoff Control Operation:

As set forth above, the smart power strip 6 transmits wake-up power and controls to turn off its manual/remote power supply/cutoff unit 50, thereby cutting off input power to the smart power strip 6. By doing so, power consumption in the smart power strip 6 is completely cut off even while the devices operate.

Meanwhile, the devices awaken as above identify whether IDs received from the master 1 are their own ones. If the received IDs are identified to be not their own, the controllers 56, 46, and 506 of the devices control to turn off the manual/remote power supply/cutoff units 50, thereby cutting off the input power. This enables complete cutoff of network standby power and standby power.

3. Normal Operation Control of IoT Device:

If the received ID is identified to be its own, the corresponding device performs event processing while communicating with the master 1.

If the power plug insertion holes 602 and 602 are not enough so that the power plug 401 or 403 is connected to the power plug insertion hole 60 or 603 of another smart power strip 6, the other smart power strip 6 is awaken in the above manner to perform the same control.

4. Normal Operation Control of Non-IoT Device:

If the non-IoT smart outlet 500 receives wake-up power from the master 1 in a power-off state so that power is remotely supplied from the outside to the IoT devices 4, 5, 6, and 500, the non-IoT smart outlet 500 wakes up, and if the ID received from the master 1 is identified as the ID registered for the non-IoT smart outlet 500, the controller 506 controls the switching unit 109 to supply input power to the power plug insertion hole 600.

As the input power is supplied, power is supplied to the non-IoT device 900 inserted into the power plug insertion hole 600.

Where the non-IoT device connected to the power plug insertion hole 600 is a non-IoT device 900 controlled by IR signals, control signals received from the master 1 are received/transmitted by the IR receiver of the non-IoT device 900 in the IR transceiver 507. At this time, the device receives the control signals and operates.

If the device normally operates, the current increases. The power measuring module 18 receives the current, and the controller 506 transmits whether the device operates normally or abnormally to the master 1 to be fed back to the smartphone or remote control device. If the device abnormally operates, the power cutoff control on the non-IoT device 900 is performed.

Where the non-IoT device connected to the power plug insertion hole 600 is a switch-controlled device, a control signal is sent to the actuator 507′ provided at the position of the switch of the non-IoT device 900 to drive the solenoid or motor of the actuator 507′, thereby pressing the switch of the non-IoT device 900 and driving the device. Meanwhile, if the device normally operates, the current increases. The power measuring module 18 receives the current, and the controller 506 transmits whether the device operates normally or abnormally to the master 1 to be fed back to the smartphone or remote control device. If the device abnormally operates, the power cutoff control on the non-IoT device 900 is performed.

5. Power Cutoff Control Operation of Non-IoT Device:

(A) in Case of Cutting Off Power Remotely

If the non-IoT device 900 receives a power off command from the master 1 while normally operating, then, in a case where the non-IoT device connected to the power plug insertion hole 600 is a non-IoT device 900 controlled by IR signals, an ‘off’ control signal received from the master 1 is received/transmitted by the IR receiver of the non-IoT device 900 in the IR transceiver 507. At this time, the non-IoT device 900 receives the control signal and terminates the event processing, and turns off the device.

If the non-IoT device 900 turns off, the current reduces so that a standby current flows. If the power measuring module 18 receives the standby current value, the controller 506 controls the switching unit 109 to turn off and transmits data (e.g., power consumption) of the device managed to the master 1, and if the master 1 transmits data with the information to the IoT smart system over the cloud and then a transmission-complete signal is received, the controller 506 turns off the manual/remote power supply/cutoff unit 50 of the non-IoT smart outlet 500, completely cutting off the input power being supplied.

Further, where the non-IoT device connected to the power plug insertion hole 600 is a switch-controlled device, the off control signal received from the master 1 is sent to the actuator 507′ to press the ‘off’ switch of the non-IoT device 900.

At this time, the non-IoT device 900 receives the control signal and terminates the event processing, and turns off the device.

If the non-IoT device 900 turns off, the current reduces, thus becoming the standby current value. The power measuring module 18 receives the standby current value, and the controller 506 controls the switching unit 109 to turn off and transmits data (e.g., power consumption) of the device managed to the master 1, and if the master 1 transmits data with the information to the IoT smart system over the cloud and then a transmission-complete signal is received, the controller 506 turns off the manual/remote power supply/cutoff unit 50 of the non-IoT smart outlet 500, completely cutting off the input power being supplied.

(B) Where non-IoT device turns off the power while using the power If the non-IoT device 900 is powered off by the power switch or remote controller of the device, the controller 506 of the non-IoT smart outlet 500 reads the standby current value of the non-IoT device 900 connected from the power measuring module 18, compares it with a standby current value as set, determines that the non-IoT device 900 is powered off, transmits data (e.g., power consumption) managed while the device operates to the master 1, and if the master 1 transmits data with the information to the IoT smart system over the cloud and a transmission-complete signal is sent and received, the controller 506 turns off the manual/remote power supply/cutoff unit 50 of the non-IoT smart outlet 500 to completely cut off the input power being supplied.

As set forth above, the non-IoT smart outlet 500 registers and stores, and controls, virtual IDs of the non-IoT devices 900 to connect the non-IoT devices 900 to the IoT smart system.

6. Remote Power Cutoff Control Operation of IoT Device:

If a power turnoff command is received by the master 1 while the device operates, the master 1 identifies its IP, ID, and password, and if they are identified as its own, transmits power off commands to the IoT devices 4 and 5 of the corresponding IDs. The IoT devices 4 and 5, upon identifying the power off commands received from the master as their own IDs, terminate the proceeding event processing, transmit data to the IoT smart system over the cloud, and upon receiving transmission-complete signals from the master 1, the controllers 56 and 46 control their respective manual/remote power supply/cutoff units 50 to cut off the input power so that the power waste in the devices 4 and 5 becomes substantially zero, allowing there to be no power waste as network standby power.

7. Manual Power Cutoff Control Operation of IoT Device:

If the manual/remote power supply/cutoff units 50 are turned off manually or using the IR remote controller or touch switch while in operation, the IoT devices 4 and 5, upon identifying the power off commands received from the master as their own IDs, terminate the proceeding event processing, transmit data to the IoT smart system over the cloud, and upon receiving transmission-complete signals from the master 1, the controllers 56 and 46 control their respective manual/remote power supply/cutoff units 50 to cut off the input power so that the power waste in the devices 4 and 5 becomes substantially zero, allowing there to be no power waste as network standby power.

Although the IoT smart home/building automation system of the present invention have been described above in connection with preferred embodiments thereof, it will be appreciated by one of ordinary skill in the art that effective power control and reduced power or energy waste may be achieved in the IoT environment by various configurations and controls as desired by users which may be implemented by changing the type of the devices or sensors.

Meanwhile, although only arbitrary preferred features of various embodiments have been described as examples, it will be apparent to one of ordinary skill in the art that various changes or modifications may be made thereto without departing from the spirit of the claims appended herewith. Therefore, it will be appreciated by one of ordinary skill in the art that the appended claims encompass all such modifications or variations without departing from the spirit of the present invention.

1. An Internet-of-Things (IoT) smart system to cut off network standby power, the IoT smart system comprising:
a master (1) including a wired/wireless power transmitter (13) to supply wake-up power to trigger operations of a gateway or a router (12) for connecting an IoT smart system platform to an external network over a cloud, a power unit 15, and IoT devices, a power supply/cutoff module (17), a power switching unit (19), and/or a communication module (11) and performing a hub function and control function;
a smart power strip (6 or 6′) connected to a smart outlet connecting to an existing power outlet (3) to connect IoT devices (4 and 5) which remain cut off from network standby power, receiving wake-up power from the master (1) to supply wake-up power to the IoT devices; and
IoT devices connected with the smart power strip.

2. The IoT smart system of claim 1, further comprising a repeater (7) provided in a middle to amplify signals to enable seamless signal transmission/reception in a poor communication environment or where wireless power transmission/reception is not seamlessly performed by nature of a building structure.

3. The IoT smart system of claim 1, wherein the smart power strip (6) is a built-in smart power strip (6′).

4. The IoT smart system of claim 1, wherein the IoT devices include at least one of devices including a configuration for cutting off the network standby power and their own standby power, devices configured to remain powered, and devices including at least one battery-powered sensor.

5. The IoT smart system of claim 1, wherein the master (1) includes:
the gateway or the router (12) for connecting to the external communication network;
the power supply/cutoff unit (17) to supply, or cut off supply of, power to the master (1) and a power plug (400) for connecting to the outlet (3) to supply input power to the master (1);
the power unit (15) generating and supplying power necessary for a wakeup power transmitter (13) upon wirelessly or wiredly transmitting power when power is supplied so that power necessary for the master (1) is connected to a power switching unit (19);
the communication module (11) for wirelessly communicating with the IoT devices;
a sleep mode power unit (14) to supply power only to some circuits including the communication module 11 and the controller 16 and cutting off the network standby power which is power wasted while there is no event processing;
the power supply/cutoff module (17) configured to cut off input power to reduce power waste by supplying power when there is event processing and cutting off the input power when there is no event processing;
the controller (16) to manage all controls regarding an event upon receiving a control event from an outside or inside, configured to gather data containing an own IP or ID and relevant data and performing computation, determination, and/or control, and store the data, and including at least one a microcomputer and a memory;
the wake-up power transmitter (13 or 13′) configured to supply wake-up power to wake up the smart power strips (6) and the IoT devices (4 and 5), which remain cut off from power, if the controller (16) identifies the own IP and ID;
the power switching unit (19) wiredly connected with the wakeup power transmitter (13) for wake-up power and configured to supply, or cut off supply of, power so that the power is supplied from the power unit (15) under control of the controller (16) only when necessary;
a power measuring module (18) configured to include a current sensor to measure power used by the master (1);
and
a power plug insertion hole (602) including the wake-up power transmitter (13) to transfer the wake-up power or a power plug insertion hole (603) configured to wiredly supply the wake-up power through the power switching unit (19).

6. (canceled)

7. The IoT smart system of claim 1, wherein the smart power strip (6) includes:
a wake-up power receiver configured to connect input power to a power plug insertion hole (601, 602, or 603) of the smart power strip (6) if an insertion terminal (406) provided in a normal power plug (400) is inserted into the outlet (3) and configured to receive the wake-up power from the master (1);
a manual/remote power supply/cutoff unit (50) operated to supply power to the power unit (15) when turned on manually or by the wake-up power and to cut off the power to the power unit (15) when turned off manually or remotely;
the power unit (15) generating necessary for the smart power strip (6) and supplying the power to the smart power strip (6 or 500) if the manual/remote power supply/cutoff unit (50) is operated so that the input power is supplied to the power unit (15) of the smart power strip (6);
a controller (66) including a microcomputer and a memory and controlling the overall smart power strip (6) including gathering various data, identifying and determining whether a device is one connected thereto, performing computation, and storing and controlling data;
the communication module (11) for communicating with the master (1);
the wake-up power transmitter (13 or 13′) configured to transmit the wake-up power to another smart power strip (6) connected and the IoT device (4 or 5) registered therein when the wake-up power is received from the master (1);
the power switching unit (19) for supplying, or cutting off supply of power from the power unit (15) to the wake-up power transmitter (13 or 13′) under control of the controller (66);
a switching unit (109) for supplying, or cutting of supply of, the wake-up power only to the IoT device (4 or 5) registered therein under control of the controller (66);
a current sensor (62) configured to detect current of the IoT device (4 or 5) connected thereto to detect standby power, and if the current is not detected, determine whether the device connected has been unplugged or plugged into a different position; and
a power plug (401 or 403) to supply power to another smart power strip (6 or 500) connected for extension of the wake-up power produced from the wake-up power transmitter (13).

8.-9. (canceled)

10. The IoT smart system of claim 1, wherein the IoT device (5) includes:
a manual/remote power supply/cutoff unit (50) configured to supply input power or manually or remotely cut off the input power under control of the controller (56) to remotely or manually supply input power while the IoT device (5) remains cut off from power or to prevent the IoT device (5) from malfunctioning as the sleep mode power supplying unit (14) is discharged so that voltage is reduced;
a power plug (402 or 403) configured to be inserted to the power plug insertion hole (602 or 603) of the smart power strip (6) to remotely supply power to the IoT device (5) so that the input power and wake-up power can be received from the manual/remote power supply/cutoff unit (50);
a wake-up power receiver to receive the wake-up power;
a power unit (55) generating and supplying power necessary for the IoT device (5) if the manual/remote power supply/cutoff unit (50) is turned on to allow the input power to be supplied to the power unit (55) of the IoT device (5);
a controller (56) including at least one microcomputer and memory and configured to process or control all events or communication of the IoT device (5) if power is supplied from the power unit (55);
the communication module (11) configured as a means to communicate with the master (1);
an input unit (51) configured to receive IR signal inputs and various sensor inputs or switch or touch switch inputs;
a display unit (52) displaying a status of the IoT device (5);
a load (53) to perform a control condition of the IoT device (5);
a sleep mode power unit (14) to supply power to least circuits including the microcomputer in a sleep mode where power is supplied to least circuits, to receive an IR input or touch switch input while the IoT device (5) remains powered off so that no power is supplied; and
a power measuring module configured t measure power used while the IoT device (5) operates.

11. The IoT smart system of claim 1, wherein the IoT device (4) includes:
a manual/remote power supply/cutoff unit (5) configured to manually or remotely supply input power in a state of the IoT device (4) remaining cut off from power or to cut off the input power manually or under control of the controller 56;
a power plug (402 or 403) configured to be inserted to the power plug insertion hole (602 or 603) of the smart power strip (6) to remotely wake up the IoT device (4) to receive the input power and the wake-up power and to manually/remotely supply the wake-up power to the manual/remote power supply/cutoff unit (50);
a wake-up power receiver to receive the wake-up power and supply the wake-up power to the manual/remote power supply/cutoff unit (50);
a power unit (45) generating and supplying power necessary for the IoT device (4) if the input power is supplied through the manual/remote power supply/cutoff unit (50);
a controller (46) including at least one microcomputer and memory and configured to process or control all events for the IoT device (4) if power is supplied from the power unit (45);
a communication module (11) configured to communicate with the master (1);
an input unit (41) configured to receive inputs from various sensors or inputs from a switch;
a display unit (42) as a means to display a status of the IoT device (4);
a load (53) to meet a control condition for the IoT device (4); and
a power measuring module (18) measuring power used while the IoT device (4) operates.

12. The IoT smart system of claim 2, wherein the repeater (7) includes:
a power plug (400) inserted to a normal outlet (3) to supply power to the repeater (7);
a power unit (75) generating and supplying power necessary for the repeater (7) if the power is supplied;
a controller (76) including a microcomputer and a memory and configured to process or control all events of the repeater (7) if power is supplied from the power unit (75);
a communication module (11) configured to amplify and relay signals for seamless communication between the master (1) and an IoT device;
a power switching unit (19) configured to provide a path for supplying, or cutting off supply of power to the wake-up power transmitter (11) from the power unit (75) to supply, or cut off supply of, the wake-up power to the IoT device (4, 5, or 6) connected to the repeater (7) if an ID registered is identified by the controller (76) from data received from the master (1);
a wake-up power transmitter (13 or 13) configured to generate and supply wake-up power to the IoT device (4, 5, or 6) if the power switching unit (19) is operated under control of the controller (76) so that power is supplied from the power unit (75); and
a power plug insertion hole (602 or 603) with a wake-up power transmitter configured to supply the wake-up power.

13. The IoT smart system of claim 1, further comprising a non-IoT smart outlet for connecting non-IoT devices, the non-IoT smart outlet (500) including:
a wake-up power receiver (101 or 101) provided in a power plug (402 or 403) matching the power plug insertion hole (602 or 603) of the smart power strip (6 or 6′) to receive the wake-up power or provided inside or outside to receive the wake-up power in a resonant wireless power transmission/reception scheme;
a manual/remote power supply/cutoff unit (50) to supply, or cut off supply of, power to the non-IoT smart outlet (500) in a state of the non-IoT smart outlet (500) remaining cut off from power, the manual/remote power supply/cutoff unit (50) being controlled when power is remotely supplied to maintain a path for supplying power to the non-IoT smart outlet (500), being manually operated even in a state of being cut off from power to maintain the path for supplying power, and cutting off power according to a control signal from the controller (506);
a power unit (505) generating and supplying power necessary for the non-IoT device (500) if the manual/remote power supply/cutoff unit (50) is operated to supply the input power to the power unit (505);
a controller (56) including at least one microcomputer and memory to process or control all events of the non-IoT smart outlet (500) if power is supplied from the power unit (505);
a communication module (11) configured to communicate with the master (1);
a power measuring module (18) including at least one sensor to measure power used while the non-IoT smart outlet (500) operates and standby power of the non-IoT smart outlet;
a switching unit (109) configured to supply, or cut off supply of, power to the power plug insertion hole (600) under control of the controller (55) when the device is identified as the non-IoT smart outlet (900) registered therein via communication with the master (1);
an input unit (508) configured input/register, at least, an ID and a control code for each non-IoT device;
an IR transceiver (507) generating an IR signal to control the device and transmitting the IR signal to the device after power is supplied to the non-IoT device in a case where the non-IoT device is an IR receiving device or an actuator (507) configurable as a solenoid or a motor in a case where the device is a device operated by pressing a switch; and
a power plug insertion hole (600) for connection of the power plug (400) of the non-IoT device (900).

14. The IoT smart system of claim 1, wherein the wake-up power transmitter (13 or 13′) includes a DC power unit to receive power through the power switching unit (19), an inverter to oscillate and supply the DC power to a transmission coil (91), and the transmission coil (91) to magnetically induce or resonate and supply power.

15. The IoT smart system of claim 1, wherein the wireless wakeup power receiver (101 or 101′) includes a reception coil (61) to receive the induced power from the transmission coil (91), a rectifier to rectify a voltage induced at the reception coil, and a DC power unit to smooth the rectified power into DC power.

16. (canceled)

17. A method for controlling power in an IoT smart system to cut off network standby power, the method comprising:
in a case where power is remotely supplied to an IoT device from an outside, if power is supplied to a master (1) and a control command is received from the outside through a gateway in a state where IoT devices connected to the IoT smart system remain cut off from power or is received from an internal sensor, identifying, by a controller (16) of the master (1), an own IP and ID and a password, if the IP and ID and password are identified as its own, controlling, by the controller (16) of the master (1), a power switching unit to supply power from a power unit (15) to a wake-up power transmitter;
converting the power into wake-up power in the wake-up power transmitter and supplying the wake-up power to a power plug insertion hole of a smart power strip (6);
applying the wake-up power received by the wake-up power receiver of the smart power strip (6) to a manual/remote power supply/cutoff unit of the smart power strip (6) to operate the manual/remote power supply/cutoff unit;
supplying input power from a power plug to a power unit (15) of the smart power strip (6);
if power is supplied to the power unit (15), generating and supplying, by the power unit (15), supply necessary for the smart power strip (6) to wake up the smart power strip (6); and
controlling, by the controller (66), the power switching unit (19) to supply the power from the power unit (15) to the wake-up power transmitter of the smart power strip (6) to create the wake-up power and to transmit the wake-up power to an IoT device connected to the power plug insertion hole of the smart power strip (6), wherein
the wake-up power received by the IoT device is applied to the manual/remote power supply/cutoff unit (50) of the IoT device, and the manual/remote power supply/cutoff unit is operated to allow input power to be supplied to the power unit of the IoT device, thereby waking up the device.

18. The method of claim 17, wherein upon checking the ID and controlling power cutoff, the smart power strip (6) transmits the wake-up power and controls to turn off the manual/remote power supply/cutoff unit to thereby cut off the input power of the smart power strip (6) so that power consumed in the smart power strip (6) is completely cut off even while the devices are operated, and the awaken devices identify whether IDs received from the master (1) are their own, and unless the IDs are identified as their own, controllers (56, 46, and 506) of the devices control to turn off the manual/remote power supply/cutoff unit to cut off the input power, thereby completely cutting off the network standby power and standby power.

19. The method of claim 17, wherein upon controlling a normal operation of the IoT device, if the ID is identified as its own, the device communicates with the master (1) and performs event processing, and if the power plug is inserted into a power plug insertion hole of another smart power strip (6) due to shortage of its power plug insertion hole, the other smart power strip (6) is awaken to perform control in the same manner.

20.-25. (canceled)

26. A smart power strip (6) for use in an IoT smart home/building automation system to cut off network standby power, the smart power strip (6) comprising:
a power plug (401) with a wake-up power transmitter (13); and
a power plug insertion hole (601) with a wake-up power receiver (101), wherein if an insertion terminal (406) provided in a normal power plug (400) is inserted into an outlet (3), input power is connected to the power plug insertion hole (601, 602, or 603) of the smart power strip (6), and if the power plug (401) is inserted into the power plug insertion hole (601), a transmission coil (91) and a reception coil (61) are configured to match each other to allow wake-up power to wirelessly be transmitted or received.

27.-29. (canceled)
